(19) United States
(12) Patent Application Publication
(10) Pub. No.: US 2013/0290074 A1
(43) Pub. Date: Oct. 31, 2013

(54) BENCHMARKING SUSTAINABILITY OF SERVICE PROVIDERS

(71) Applicants: Cullen E. Bash, Los Gatos, CA (US); Yuan Chen, Sunnyvale, CA (US); Daniel Juergen Gmach, Palo Alto, CA (US); Kiara Groves Corrigan, Burlingame, CA (US); Dejan S. Milojicic, Palo Alto, CA (US); Amip J. Shah, Santa Clara, CA (US)

(72) Inventors: Cullen E. Bash, Los Gatos, CA (US); Yuan Chen, Sunnyvale, CA (US); Daniel Juergen Gmach, Palo Alto, CA (US); Kiara Groves Corrigan, Burlingame, CA (US); Dejan S. Milojicic, Palo Alto, CA (US); Amip J. Shah, Santa Clara, CA (US)

(21) Appl. No.: 13/456,561

(22) Filed: Apr. 26, 2012

(51) Int. Cl. G06Q 10/06

(52) U.S. Cl. 705/7.39

(57) ABSTRACT

A method of benchmarking a sustainability for service providers using a program having executable computer-readable instructions first includes selecting a plurality of service providers to evaluate for sustainability. A report is received from each of the selected service providers which includes at least one reported value characteristic having a value metric and at least one reported cost characteristic having a cost metric. The reported cost and value characteristics are compared to select at least one common value characteristic and at least one common cost characteristic each of which is common among the selected service providers. A service sustainability relationship is then computed as a function of the at least one common value characteristic and the at least one common cost characteristic to benchmark the sustainability of each of the selected service providers relative to one another.

### BACKGROUND

Cloud-computing is proliferating worldwide as a result of the demand for information technology (IT) services. This growing demand has increased the energy consumption of data centers, leading to increased costs, carbon emissions, water usage and other environmental impacts.

### DESCRIPTION OF THE DRAWINGS

The detailed description will refer to the following Figures in which like numerals refer to like items, and in which:

FIG. 1 illustrates an embodiment of a system to compute a service sustainability relationship for service providers;

FIG. 2 is a flowchart illustrating an embodiment of a method of computing the service sustainability relationship for service providers;

FIG. 3 is a flowchart illustrating an embodiment of a method of receiving value characteristics and cost characteristics from service providers;

FIG. 4 illustrates an example of an electronic service questionnaire used with the method of FIG. 3;

FIG. 5 is a flowchart illustrating an embodiment of a method of computing a service value relationship from the service characteristics and a service cost relationship from the cost characteristics;

FIG. 6 is a flowchart illustrating an embodiment of a method of benchmarking sustainability for service providers as a function of the service value relationship and the service cost relationship; and

FIG. 7 is a flowchart illustrating an embodiment of a method of verifying a report received from the service providers.

### DETAILED DESCRIPTION

Sustainability metrics which track the power consumption and environmental impacts of data centers and overall clouds at the infrastructure level and service level have become an increasingly important consideration for which decision makers rely on when implementing their data center and cloud computing needs. However, it is currently difficult to compare IT service providers at the service level with regard to sustainability, especially when sustainability metrics can be calculated using inconsistent characteristics. Accordingly, decision makers lack accurate and simple models to use and rely on when making decisions to implement IT service needs for the data center or cloud.

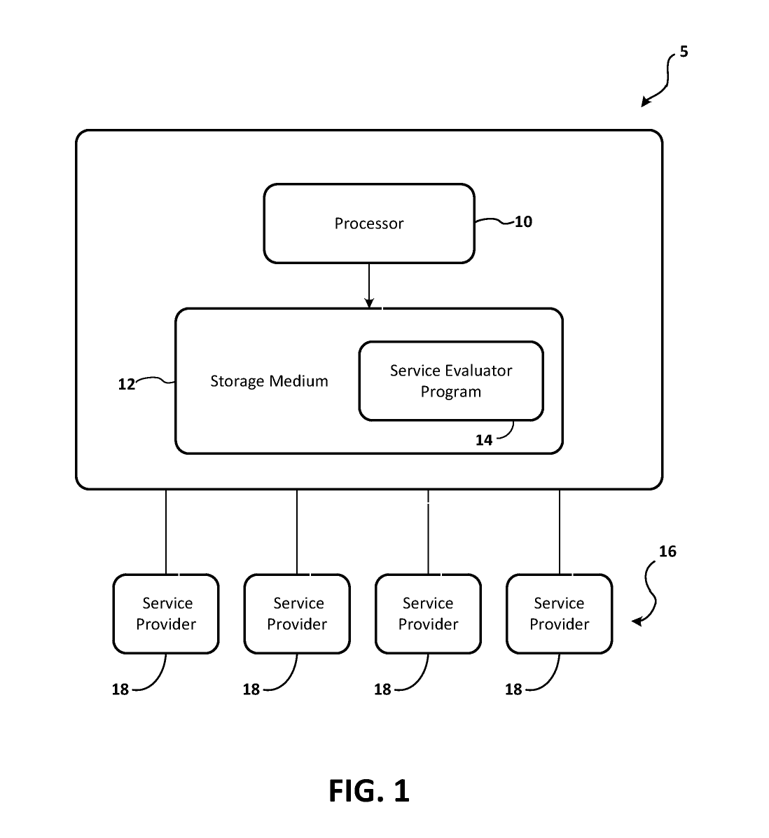

FIG. 1 illustrates an embodiment of a system 5 to compute a service sustainability relationship for service providers. In FIG. 1, system 5 includes processor 10 and service evaluator program 12 having machine-readable instructions stored on computer-readable storage medium 14 to evaluate at least one class of services 16 with regard to sustainability. The processor 10 is in communication with service providers 18 within the service class 16. The service providers 18 can be information technology (IT) service providers, and thus the service class 16 can be an IT service class. However, any type of service providers 18 and service class 16 can be evaluated.

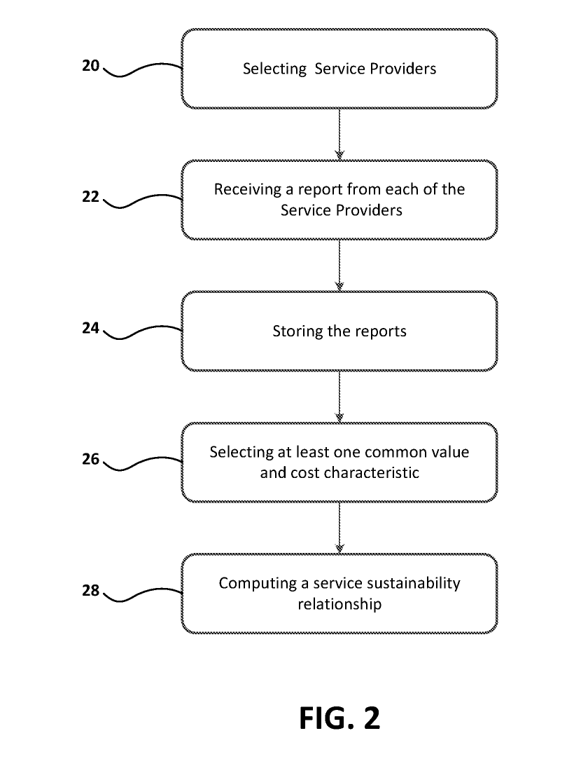

FIG. 2 is a flowchart illustrating an embodiment of a method of computing the service sustainability relationship for the service providers 18. As shown in FIG. 2, the method begins at block 20 by selecting service providers 18 from the service class 16, and then at block 22 receiving a report from each of the selected service providers 18, with each report including at least one reported value characteristic having a value metric and at least one reported cost characteristic having a cost metric. For example, the value characteristics may include a number of users of the service, Quality of Service (QoS), or scalability. The service characteristic may include economic costs and ecological costs such as carbon emission, water usage, resource usage, and the like. However, any other characteristic which is associated with a service of the service provider can be reported.

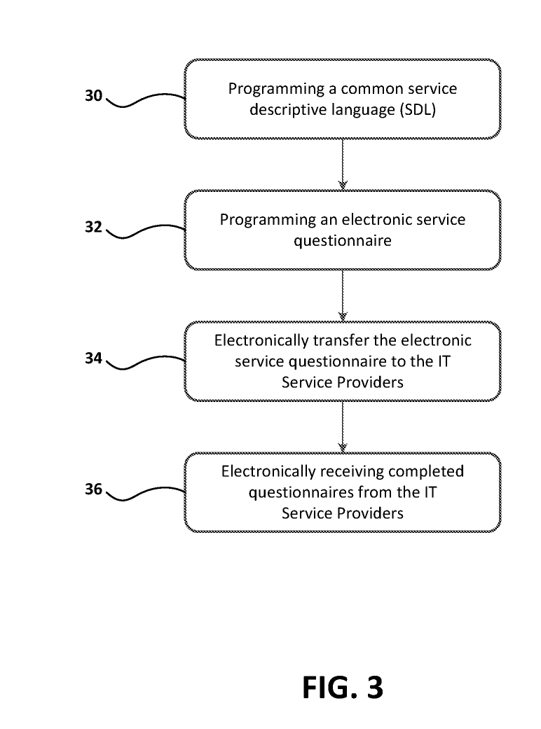

FIG. 3 illustrates an embodiment of a method of receiving value characteristics and cost characteristics from, for example, the IT service providers. As shown in FIG. 3, the method of FIG. 2 can include in block 30 programming an electronic service questionnaire which is programmed by the processor 10 to compile a list of these cost and service characteristics and the associated metrics that are used by the IT service providers 18 within the IT service class 16. However, the report of block 22 could include any service reports that are published by the IT service providers 18 within the IT service class 16. In the example where the method includes the block of 30 programming the electronic service questionnaire, the method proceeds in block 32 by programming a common service descriptive language (SDL) by the processor 10 to facilitate electronic data transfer between the IT service providers 18 and the service evaluator program 12 in communication with the processor 10, and then the processor 10 can in block 34 electronically transfer the service questionnaire from the service evaluator program 12 to the selected IT service providers 18. The common SDL of the method is used in the same way as a web service definition language (WSDL) is used to describe service functionality using a description language. The method then proceeds by 36 electronically receiving the plurality of completed questionnaires from the IT service providers 18 wherein each questionnaire includes a reporting by the IT service provider 18 of at least one value characteristic having a value metric and at least one cost characteristic having a cost metric. An important aspect of the either reporting block 22, 36 is the gathering of sufficient data to ultimately establish a service sustainability relationship for the IT service providers 18 in the ensuing steps. In addition, for purposes of addressing security issues, the completed reports and questionnaires can be protected and only offered to specific IT service providers 18 who will abide to keep all information confidential.

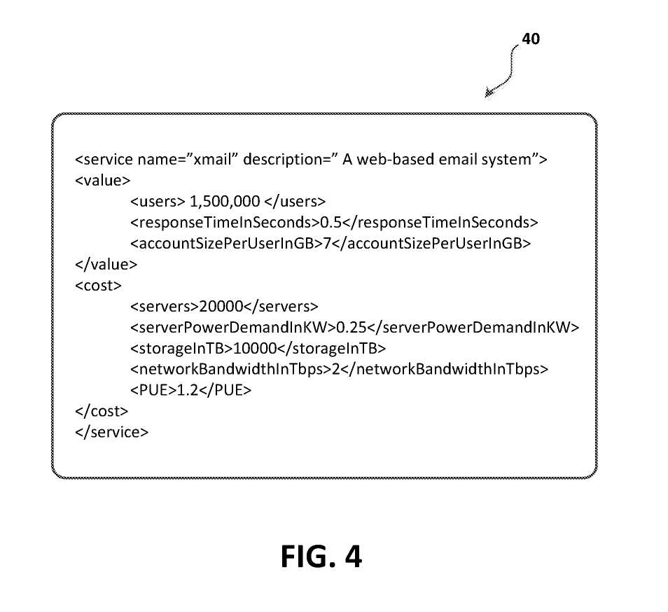

FIG. 4 illustrates an example of the electronic service questionnaire 40 that can be generated in step 32 and electronically received from, for example, the IT service providers 18 in block 36. As illustrated in FIG. 4, the questionnaire 40 is generated for an email service, and includes sufficient metrics to derive the value of the email service and the cost of the email service. As also shown in FIG. 4, the completed report or questionnaire 40 provides detailed information such as for example how many users the email service supports, the average size of each email account, the number of servers, storage size and bandwidth as well as the cooling energy consumption (via PUE) of the data center hosting the service.

Once the electronic service questionnaires 40 or reports are received from, for example, each of the selected IT service providers 18, the method proceeds by 24 storing the questionnaires or reports on the computer-readable storage medium 14. The method proceeds at block 26 by comparing the reported cost and value characteristics from each of the completed questionnaires 40 with the service evaluator program 12 to select at least one common value characteristic and at least one common cost characteristic each of which is common among each of the IT service providers 18 within the IT service class 16. For example, if the email service as described above is being evaluated, a common value characteristic reported by each of the email service providers could be number of users, the amount of storage allotted to each user, or a Quality of Service metric such as delivery time. Correspondingly, a common cost characteristic reported by each of the email service providers could be the average cost to deliver the email service such as economic cost in dollars or ecological cost in terms of carbon emission, water use, or other resource consumption. However, for each of the cost and value characteristics, any characteristic which may be reported by each of the IT service providers 18 can be identified by the service evaluator program 12.

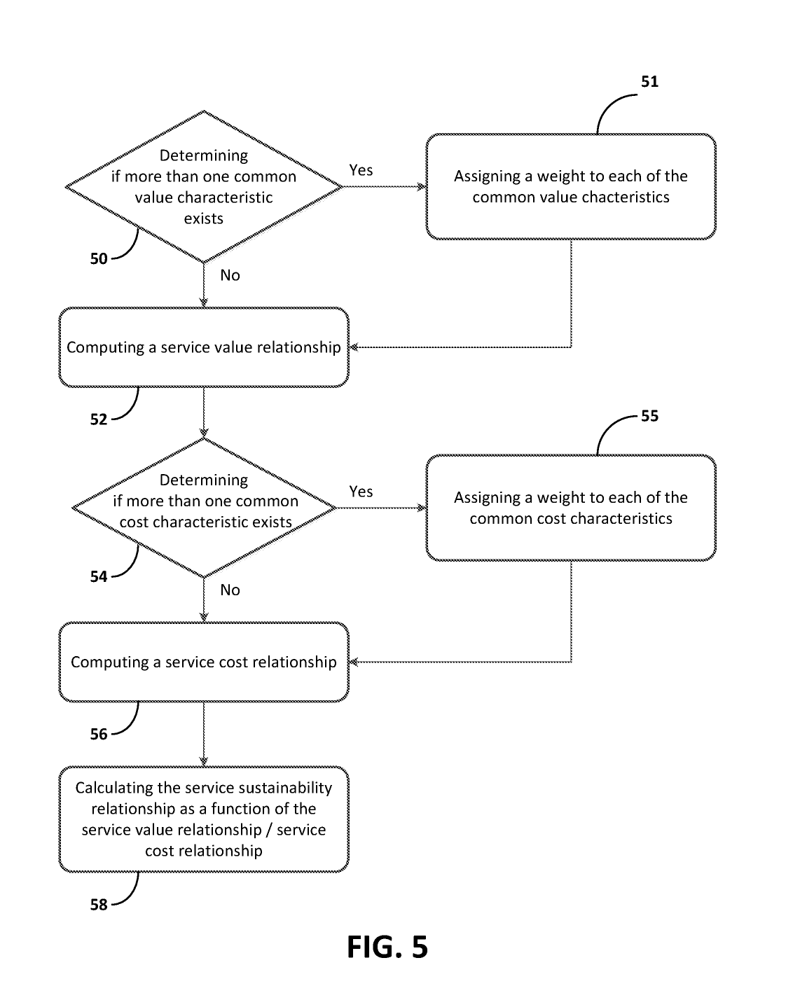

Once the common cost and value characteristics of, for example, the IT service providers 18 are identified, the method proceeds by at block 28 by computing a service sustainability relationship for the selected service providers 18 as a function of the at least one common value characteristic and the at least one common cost characteristic. FIG. 5 is a flowchart illustrating an embodiment of a method of computing a service value relationship from the service characteristics and a service cost relationship from the cost characteristics. As shown in FIG. 5, an example of the computing of the service value relationship block 28 can first include 50 determining if more than one common value characteristic exists, and if not then, at block 52, computing a service value relationship for the service class 16 as a function of the common value characteristic. The method then proceeds at block 54 determining if more than one common cost characteristic exists, and if not then at block 56 computing a service cost relationship for the service class as a function of the common cost characteristic. A variety of equations or relationships can be utilized to estimate or generate the service cost relationship and the service value relationship. However, in any aspect of blocks 52 and 54, the relationship is computed based on the commonly occurring cost and value characteristics that are published by each of the service providers 18.

In the situation where multiple value characteristics are identified at block 50, the method would proceed at block 51 by selecting a number of common value characteristics each of which is common among each of the service providers 18 and assigning a weight to each of the common value characteristics. Block 52 of computing the service value relationship would then include computing the service value relationship using the weights assigned to the plurality of common value characteristics. Also, in the situation where multiple cost characteristics are identified at block 54, the method would proceed at block 55 by selecting a number of common cost characteristics each of which is common among each of the service providers 18 and assigning a weight to each of the common cost characteristics. Block 56 of computing the service cost relationship would then include computing the service value relationship using the weights assigned to the plurality of common value characteristics. In other words, a combination of weights assigned by the service providers 18 can be considered to generate the service value relationship or the service cost relationship, or weights independent of the service providers 18 input can be generated by the processor 10 and/or the service evaluator program 12 to devise a common representation of the service value or the service cost using a weighted sum of the multiple common characteristics. Thus, the steps of generating the service value relationship and the service cost relationship 52, 56 involves consolidating different cost and value definitions published by various service providers such that the service costs and service values can be normalized into a single metric for each service provider 18 that can then be used in the ensuing steps of the method to compute the service sustainability relationship for the service class 16.

Once the service value relationship and the service cost relationship have been generated, the method proceeds at block 58 by computing the service sustainability relationship as a function of the ratio of the customer value derived from the service to the cost required to provide the service. In other words, the service sustainability relationship is calculated by dividing the service value relationship by the service cost relationship. However, any other service sustainability relationships can be generated and used to characterize and benchmark the sustainability for the IT service providers.

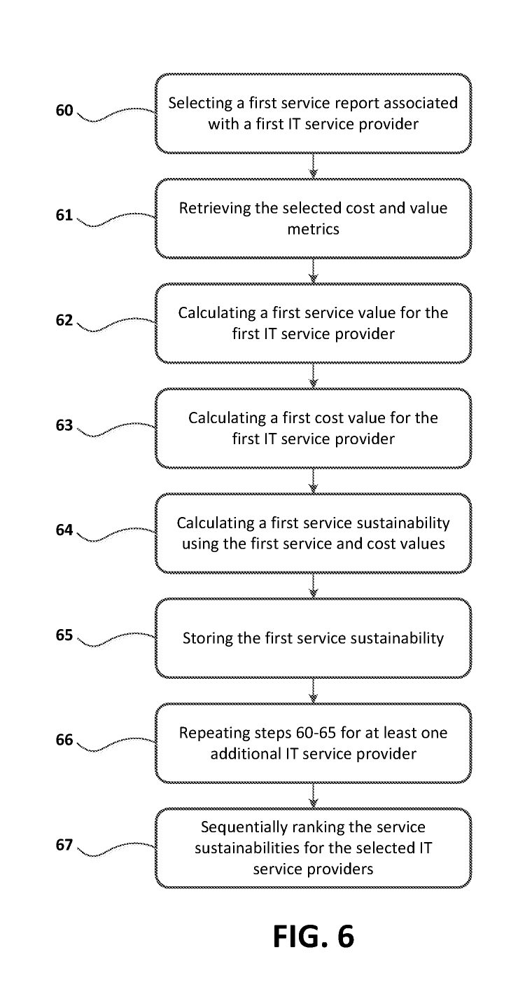

Once the service sustainability relationship has been generated, the method can proceed to benchmark a sustainability for each of the IT service providers 18. FIG. 6 is a flowchart illustrating a method of benchmarking the sustainability for each of, for example, the IT service providers as a function of the service value relationship and the service cost relationship. As shown in FIG. 6, the method proceeds at block 60 by selecting a first report or completed questionnaire associated with a first service provider from the database and 61 retrieving the selected value and cost metrics from the first report or completed questionnaire. The method then proceeds at block 62 by calculating a first service value for the first IT service provider in response to an inputting of the selected service value metric into the service value relationship, and at block 63 by calculating a first service cost for the first IT service provider in response to an inputting of the selected cost metric into the service cost relationship. Once the service value relationship and the service cost relationship are generated, the method proceeds at block 64 by computing a first service sustainability value as a function of the first service value and the first service cost to estimate a sustainability of the first IT service provider. As mentioned previously, the computing of the first service sustainability can include calculating a ratio of the first service value to the first service cost. Once the first service sustainability value is calculated, the method proceeds at block 65 by storing the first service sustainability value associated with the first IT service provider in the computer-readable storage medium 14.

The method then proceeds at block 66 by repeating the steps as outlined for the first selected IT service provider for at least one additional selected IT service provider. Said another way, service sustainability values are calculated for any additional IT service providers which are desired to be benchmarked for sustainability. Once all the additional service sustainability values are calculated for the IT service providers, they are stored in the computer-readable storage medium 14. The service evaluator program 12 then proceeds at block 67 by sequentially ranking the service sustainability values associated with the selected IT service providers 18 to benchmark the sustainability of each of the selected service providers 18 relative to one another. Accordingly, a single value representing the service sustainability for each of the selected IT service providers 18 is derived, and thus provides for simplicity by benchmarking service sustainability among IT service providers using the single sustainability metric.

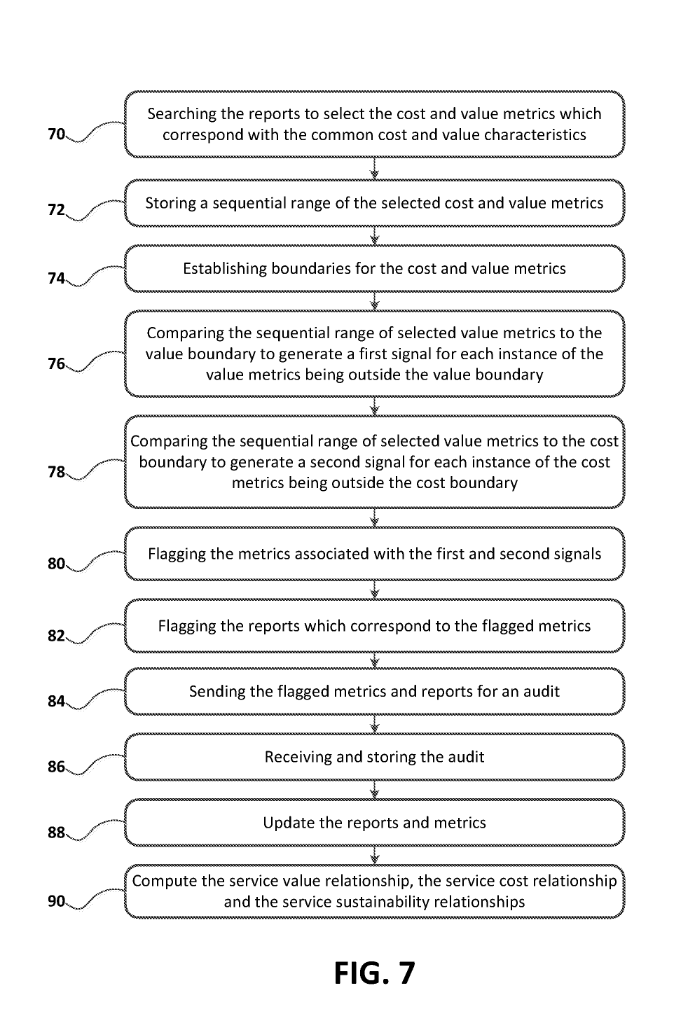

It is also a subject of the method that the metrics and characteristics provided by, for example, the IT service providers 18 in the report or electronic service questionnaires 40 can be verified prior to computing the service sustainability relationships to guarantee that any ensuing service sustainability benchmarking which is conducted using this information is accurate and correct. In this example, as best shown in FIG. 7, prior to computing the service sustainability relationship the method includes at block 70 by searching the reports or completed questionnaires with the service evaluator program 12 to select the cost and value metrics which correspond to the common value characteristic and the common cost characteristic for each of the IT service providers 18. Said another way, the service evaluator program 12 identifies the actual metrics that were reported by each of the IT service providers 18 for the common value characteristic and the common cost characteristic. The method proceeds at block 72 by storing a sequential range of the selected cost and value metrics. The method then includes at block 74 by establishing boundaries or notions of anomalies for which to compare the sequential range of the selected cost and value metrics. These boundaries and notions of anomalies can be established using a range of techniques. For example, the block of 74 establishing of boundaries could include selecting a sample of reports to be reviewed by third-party certified life cycle assessment practitioners and then receiving a reporting back of the boundaries from the third-party practitioners. These boundaries and notions of anomalies could also be established based on industry-average representative models. Additionally, anomaly detection could be used to identify unusual occurrences in the reporting from amongst a cluster of the different reports. In an implementation of block 74, an economic input-output life-cycle assessment (EIO-LCA) approach could be used to obtain an “industry average” value for each of the component sectors which underly the IT service class, such that the expected sustainability footprint of the sector would simply be the sum of the footprint of the associated sectors. Alternatively, the boundaries or anomalies could be established based on literature surveys of other service providers delivering a similar service who may have already reported the associated sustainability characteristics or an expected range of values for the service delivery.

In any of these approaches, block 74 of establishing the boundaries includes establishing a predetermined cost benchmark having a minimum cost and a maximum cost and establishing a predetermined value benchmark having a minimum value and a maximum value. The method then proceeds at block 76 by comparing the sequential range of the cost metrics to the cost boundary including the predetermined cost benchmark to generate a first auditing signal for each instance of the selected cost metric being below the minimum cost and each instance of the selected cost metric being above the maximum cost. The method also proceeds at block 78 by comparing the sequential range of the selected value metrics to the value boundary including the predetermined value benchmark to generate a second auditing signal for each instance of the selected value metric being below the minimum value and each instance of the selected value metric being above the maximum value. The method then proceeds at block 80 by flagging the corresponding metrics in response to the first and second auditing signals, and then 82 flagging the reports or completed questionnaires which correspond to the flagged metrics. In the instance where there are violations as indicated by receipt of the first and second auditing signals, the method can proceed at block 84 by sending the flagged metrics and the flagged reports or questionnaires from the service evaluator program 12 to a third party auditor to confirm the cost and value metrics reported by the flagged IT service providers 18. In an example, the method will include at block 86 by the service evaluator program receiving and storing an audit report from the auditor which includes at least one adjusted metric. The method can then proceed at block 88 by electronically updating the flagged questionnaires and the flagged metrics in response to the adjusted metric in the audit report, and at block 90 by computing the service value relationship, the service cost relationship and the service sustainability relationships as outlined above using these adjusted metrics. As mentioned previously, these auditing steps are advantageous because they help to guarantee the service sustainability benchmarking which is conducted in the ensuing steps is accurate.

We claim:

1. A method of benchmarking a sustainability for service providers comprising:
receiving a report from a plurality of selected service providers, each report including at least one reported value characteristic having a value metric and at least one reported cost characteristic having a cost metric;
comparing the reported cost and value characteristics to select at least one common value characteristic and at least one common cost characteristic each of which is common among the selected service providers; and
computing a service sustainability relationship for the selected service providers as a function of the at least one common value characteristic and the at least one common cost characteristic to benchmark the sustainability of each of the selected service providers relative to one another.

2. The method of claim 1 further comprising:
computing a service value relationship for the selected service providers as a function of the common value characteristic;
computing a service cost relationship for the selected service providers as a function of the common value characteristic; and
computing the service sustainability relationship as a function of the service value relationship and the service cost relationship.

3. A method as set forth in claim 2 wherein the service sustainability relationship includes a ratio of the service value relationship to the service cost relationship.

4. A method as set forth in claim 2 further comprising:
a) selecting a first report associated with a first service provider;
b) searching the report to select the cost and value metrics which correspond to the common value characteristic and the common cost characteristic;
c) calculating a first service value for the first service provider in response to an inputting of the selected value metric into the service value relationship;
d) calculating a first service cost for the first service provider in response to an inputting of the selected cost metric into the service cost relationship; and
e) calculating a first service sustainability value for the first service provider in response to an inputting of the first service value and first service cost into the service sustainability relationship.

5. A method as set forth in claim 4 further comprising:
repeating steps a.) through e.) for at least one additional selected service provider; and
sequentially ranking the service sustainability values associated with the selected service providers.

6. A method as set forth in claim 2 further comprising:
wherein the step of comparing the reported value characteristics includes selecting a plurality of common value characteristics each of which is common among each of the service providers within the service class; and
wherein the step of computing the service value relationship includes assigning a weight to each of the common value characteristics.

7. A method as set forth in claim 2 further comprising:
wherein the step of comparing the reported cost characteristics includes selecting a plurality of common cost characteristics each of which is common among each of the service providers within the service class; and
wherein the step of computing the service cost relationship includes assigning a weight to each of the common service cost characteristics.

8. A method as set forth in claim 1 further comprising:
generating the report including an electronic service questionnaire to compile a list of the value and cost characteristics and associated metrics utilized by the service providers;
electronically transferring the report to the selected service providers; and
receiving the completed report from the service providers.

9. A method as set forth in claim 8 further comprising:
programming a common service descriptive language (SDL) to facilitate electronic data transfer of the report to the service providers; and
wherein the report and the service questionnaire is generated in the SDL.

10. A method as set forth in 1 further comprising:
searching the reports to select the cost and value metrics which correspond to the common value characteristic and the common cost characteristic;
establishing a sequential range of the selected value metrics and the selected cost metrics;
comparing the sequential ranges of the selected cost metrics to a predetermined cost benchmark having a minimum cost and a maximum cost;
generating a first auditing signal for each instance of the selected cost metric being below the minimum cost and each instance of the selected cost metric being above the maximum cost;
comparing the sequential range of the selected value metrics to a predetermined value benchmark having a minimum value and a maximum value;
generating a second auditing signal in response to each instance of the selected metrics being below the minimum value and each instance of the selected value metric being above the maximum value; and
conducting an audit of the metrics associated with the auditing signals.

11. A computer-readable storage medium having machine readable instructions that when executed by a processor cause the processor to:
receive a report from a plurality of selected service providers, each report including at least one reported value characteristic having a value metric and at least one reported cost characteristic having a cost metric;
compare the reported cost and value characteristics to select at least one common value characteristic and at least one common cost characteristic each of which is common among the selected service providers; and
compute a service sustainability relationship for the selected service providers as a function of the at least one common value characteristic and the at least one common cost characteristic to benchmark the sustainability of each of the selected service providers relative to one another.

12. The machine-readable instructions as set forth in claim 11 which further cause the processor to:
compute a service value relationship for the service providers as a function of the common service value characteristic;
compute a service value relationship for the service providers as a function of the common service cost characteristic; and
wherein the service sustainability relationship includes a ratio of the service value relationship to the service cost relationship.

13. The machine-readable instructions as set forth in claim 12 which further cause the processor to:
a.) select a first report associated with a first service provider;
b.) search the report to select the cost and value metrics which correspond to the common value characteristics and the common cost characteristic;
c.) calculate a first service cost for the first service provider in response to an inputting of the selected cost metric into the service cost relationship;
d.) calculate a first service value for the first service provider in response to an inputting of the selected value metric into the service value relationship; and
e.) calculate a first service sustainability value for the first service provider in response to dividing the first service value by the first service cost.

14. The machine readable instructions of claim 13 which further to cause the processor to:
repeat steps a.) through e.) for at least one additional service provider; and
sequentially rank the service sustainability values associated with the selected service providers to benchmark the sustainability of each of the selected service providers relative to one another.

15. A method for benchmarking a sustainability of a plurality of service providers within a service class using a processor and a service evaluator program having executable machine-readable instructions stored on a computer-readable storage medium, the method comprising the steps of:
a) selecting a plurality of service providers from a service class;
b) generating an electronic service questionnaire to compile a list of service characteristics and associated metrics utilized by the service providers within the service class;
c) electronically transferring the service questionnaire from the service evaluator program to the selected service providers;
d) electronically receiving and storing a plurality of completed questionnaires from the service providers which each include a reporting by the service provider of at least one value characteristic having a value metric and at least one cost characteristic having a cost metric;
e) comparing the reported cost and value characteristics from each of the completed questionnaires with the service evaluator program to select at least one common value characteristic and at least one common cost characteristic each of which is common among each of the service providers within the service class;
f) searching the completed questionnaires with the service evaluator program to select the cost and value metrics which correspond to the common value characteristic and the common cost characteristic;
g) computing a service value relationship for the service class as a function of the at least one common value characteristic;
h) computing a service cost relationship for the service class as a function of the at least one common cost characteristic;
i) selecting a first completed questionnaire associated with a first service provider from the database;
j) retrieving the selected value and cost metrics from the first completed questionnaire;
k) calculating a first service value for the first service provider in response to an inputting of the selected service metric into the service value relationship;
l) calculating a first service cost for the first service provider in response to an inputting of the selected service cost metric into the service cost relationship;
m) calculating a first service sustainability value as a function of a ratio of the first service value and the first service cost to estimate a sustainability of the first service provider;
n) storing the first service sustainability value associated with the first service provider in the computer-readable storage medium;
o) repeating steps i.) thru n.) for each of the selected service providers to compute and store a plurality of service sustainabilities; and
p) sequentially ranking the service sustainability values associated with the selected service providers to benchmark the sustainability of each of the selected service providers relative to one another.
